(19) United States
(12) Patent Application Publication
(10) Pub. No.: US 2024/0396174 A1
(43) Pub. Date: Nov. 28, 2024

(54) POWER STORAGE CELL

(71) Applicant: TOYOTA JIDOSHA KABUSHIKI KAISHA, Toyota-shi (JP)

(72) Inventors: Atsushi SUGIHARA, Toyota-shi (JP); Kenichi KAKISHITA, Nagoya-shi (JP); Jun IZUMI, Toyota-shi (JP); Tetsuya MIMURA, Chiryu-shi (JP); Kota OHATA, Toyota-shi (JP); Nana KURASHITA, Toyota-shi (JP); Yuki TAKAHASHI, Miyoshi-shi (JP)

(73) Assignee: TOYOTA JIDOSHA KABUSHIKI KAISHA, Toyota-shi (JP)

(21) Appl. No.: 18/658,438

(22) Filed: May 8, 2024

(30) Foreign Application Priority Data
May 25, 2023 (JP) 2023-086246

(51) Int. Cl. H01M 50/466; H01M 10/04; H01M 50/103

(52) U.S. Cl. CPC H01M 50/466; H01M 10/0431; H01M 50/103

(57) ABSTRACT

A power storage cell includes an electrode assembly and a cell case containing the electrode assembly. The electrode assembly includes a plurality of electrodes arranged in one direction, and a separator formed in a fanfold shape. The separator includes: a plurality of intervening portions each intervening between a pair of electrodes adjacent to each other in the one direction; an upper folded portion; and a lower folded portion. At least one of the upper folded portion and the lower folded portion is provided with a discharge hole for discharging gas.

### CROSS REFERENCE TO RELATED APPLICATIONS

This nonprovisional application is based on Japanese Patent Application No. 2023-086246 filed on May 25, 2023 with the Japan Patent Office, the entire contents of which are hereby incorporated by reference.

### BACKGROUND

### Field

The present disclosure relates to a power storage cell.

### Description of the Background Art

Japanese Patent Laying-Open No. 2016-143550 discloses a battery cell including a fanfold stack structure and an exterior package. The fanfold stack structure includes a plurality of positive electrode plates, a plurality of negative electrode plates, and a separator formed in a fanfold shape and disposed between the positive electrode plate and the negative electrode plate.

### SUMMARY

In the battery cell described in Japanese Patent Laying-Open No. 2016-143550, when gas is generated in the fanfold stack structure, the gas may stay in the fanfold stack structure.

It is an object of the present disclosure to provide a power storage cell that enables prevention of gas from staying in an electrode assembly.

According to one aspect of the present disclosure, a power storage cell includes: an electrode assembly; and a cell case containing the electrode assembly, wherein the electrode assembly includes: a plurality of electrodes arranged in one direction; and a separator formed in a fanfold shape and electrically insulating the plurality of electrodes from each other, the separator includes: a plurality of intervening portions each intervening between a pair of electrodes adjacent to each other in the one direction; an upper folded portion connecting an upper end of one intervening portion of the plurality of intervening portions, and an upper end of an intervening portion of the plurality of intervening portions that is located on one side in the one direction and adjacent to the one intervening portion; and a lower folded portion connecting a lower end of the one intervening portion of the plurality of intervening portions, and a lower end of an intervening portion of the plurality of intervening portions that is located on the other side in the one direction and adjacent to the one intervening portion, and at least one of the upper folded portion and the lower folded portion is provided with a discharge hole for discharging gas.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a power storage cell according to an embodiment of the present disclosure.

FIG. 2 is a cross-sectional view of the power storage cell shown in FIG. 1.

FIG. 3 is a cross-sectional view of an electrode assembly.

FIG. 4 is a plan view of a separator before the separator is formed in a fanfold shape.

FIG. 5 is a perspective view schematically showing a process of connecting an electrode tab and a current collector tab.

### DESCRIPTION OF THE PREFERRED EMBODIMENTS

Embodiments of the present disclosure will be described with reference to the drawings. In the drawings referred to below, the same or corresponding members are denoted by the same reference numerals.

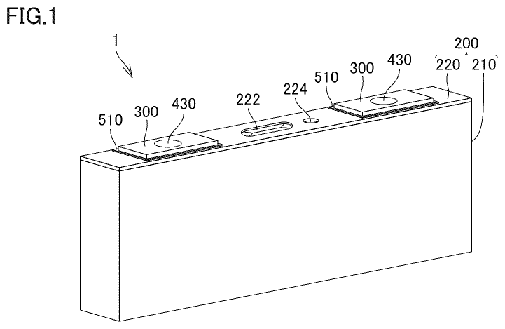

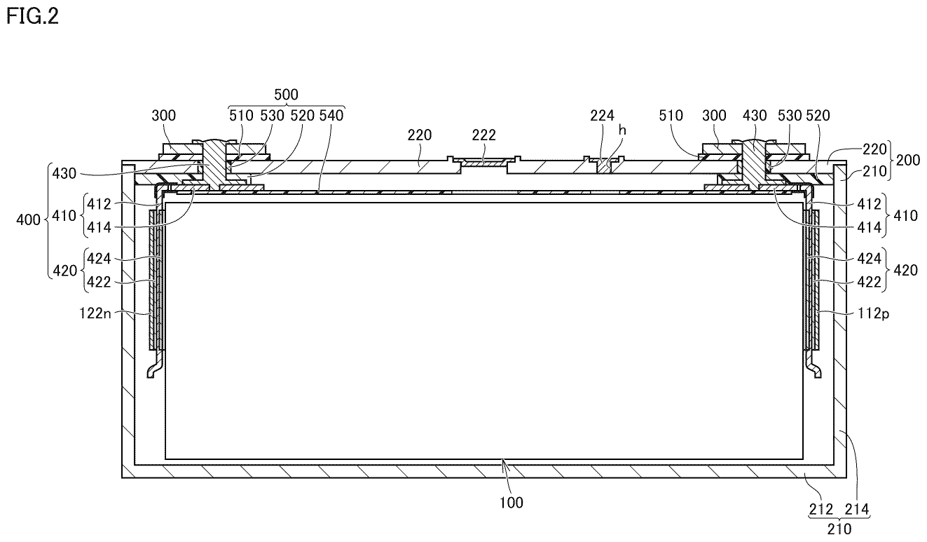

FIG. 1 is a perspective view schematically showing a power storage cell according to an embodiment of the present disclosure. FIG. 2 is a cross-sectional view of the power storage cell shown in FIG. 1.

As shown in FIGS. 1 and 2, the power storage cell 1 includes an electrode assembly 100, a cell case 200, an electrolyte solution (not shown), a pair of external terminals 300, a pair of connecting members 400, and an insulating member 500.

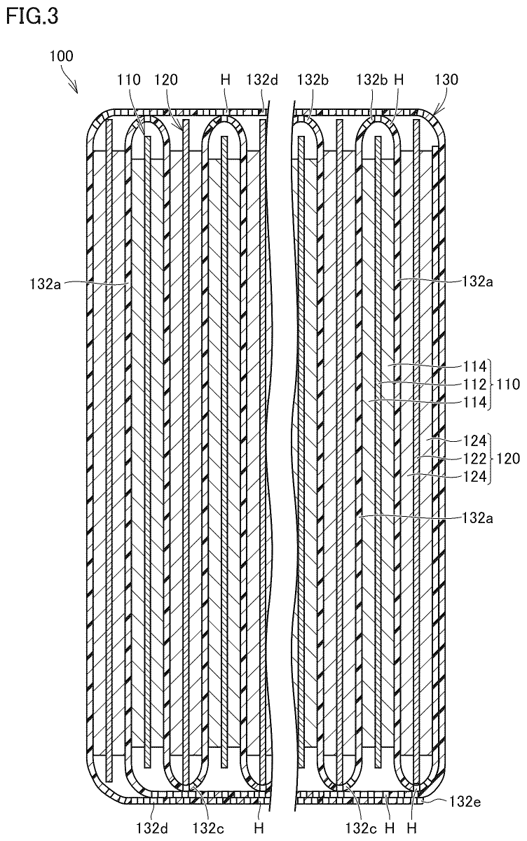

FIG. 3 is a cross-sectional view of the electrode assembly. As shown in FIG. 3, the electrode assembly 100 includes a plurality of electrodes 110 and 120 and a separator 130.

As shown in FIG. 3, the plurality of electrodes 110 and 120 are arranged side by side in one direction (the left-right direction in FIG. 3). The plurality of electrodes 110 and 120 have a plurality of positive electrodes 110 and a plurality of negative electrodes 120.

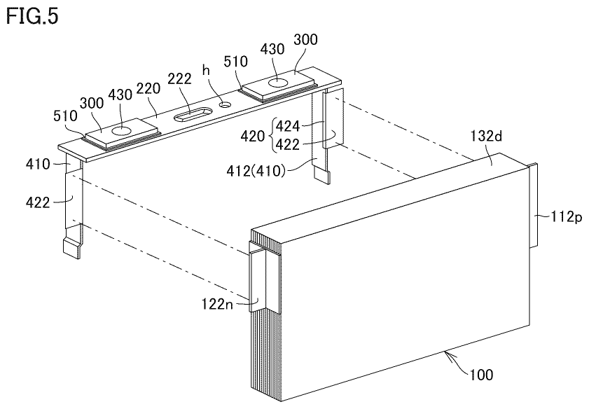

Each positive electrode 110 is formed in a rectangular shape elongated in the width direction (direction orthogonal to both the one direction and the top-bottom direction). Each positive electrode 110 includes a positive electrode current collector foil 112 and a positive electrode active material layer 114 provided on both surfaces of the positive electrode current collector foil 112. As shown in FIGS. 2 and 5, the positive electrode current collector foil 112 has a positive electrode tab 112p in which the positive electrode active material layer 114 is not provided. The positive electrode tab 112p protrudes toward one side in the width direction (a direction orthogonal to the plane of FIG. 3).

Each negative electrode 120 is formed in a rectangular shape elongated in the width direction. Each negative electrode 120 includes a negative electrode current collector foil 122 and a negative electrode active material layer 124 provided on both surfaces of the negative electrode current collector foil 122. As shown in FIGS. 2 and 5, the negative electrode current collector foil 122 has a negative electrode tab 122n in which the negative electrode active material layer 124 is not provided. The negative electrode tab 122n protrudes toward the other side in the width direction.

The separator 130 electrically insulates the positive electrode 110 from the negative electrode 120. The separator 130 is made of an insulating material, and has minute voids that allow penetration of ions. As shown in FIG. 3, the separator 130 is formed in a fanfold shape.

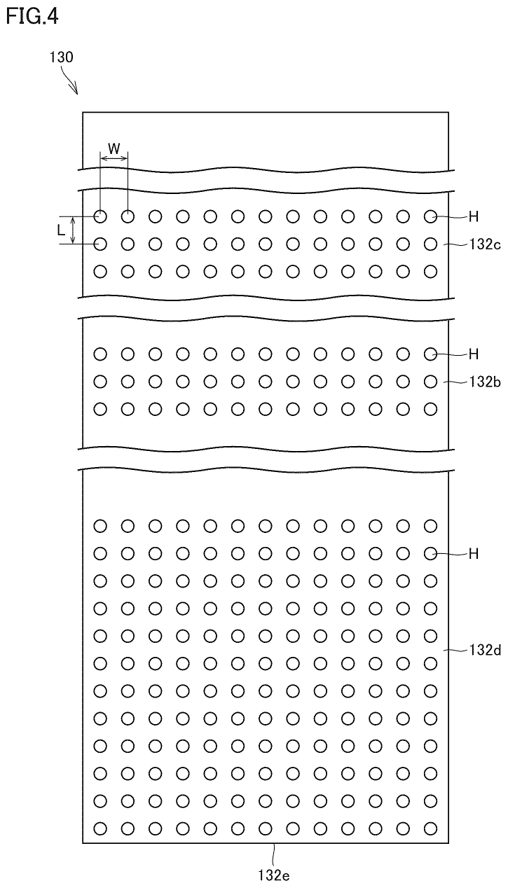

FIG. 4 is a plan view of the separator before the separator is formed in a fanfold shape. As shown in FIG. 4, the separator 130 has a rectangular shape before formed in a fanfold shape. The separator 130 is folded between the electrodes 110 and 120. As shown in FIG. 3, the separator 130 includes a plurality of intervening portions 132a, a plurality of upper folded portions 132b, a plurality of lower folded portions 132c, and an outermost covering portion 132d.

Each intervening portion 132a is interposed between a pair of electrodes 110 and 120 adjacent to each other in one direction. That is, each intervening portion 132a has a function of electrically insulating the positive electrode 110 and the negative electrode 120. Each intervening portion 132a is configured by a rectangular region.

The upper folded portion 132b connects an upper end of one intervening portion 132a of the plurality of intervening portions 132a and an upper end of an intervening portion 132a of the plurality of intervening portions 132a that is located on one side in the one direction and adjacent to the one intervening portion 132a. In the present embodiment, the upper folded portion 132b is disposed above the positive electrode 110.

Each lower folded portion 132c connects a lower end of the one intervening portion of the plurality of intervening portions 132a and a lower end of an intervening portion 132a of the plurality of intervening portions 132a located on the other side in the one direction and adjacent to the one intervening portion. In the present embodiment, the lower folded portion 132c is disposed below the negative electrode 120. In other words, the negative electrode 120 is disposed on the lower folded portion 132c.

The outermost covering portion 132d collectively covers the upper folded portions 132b and the lower folded portions 132c. More specifically, the outermost covering portion 132d collectively covers all of the electrodes 110 and 120, all of the intervening portions 132a, all of the upper folded portions 132b, and all of the lower folded portions 132c while winding around a central axis parallel to the width direction. The terminal end 132e (see FIGS. 3 and 4) of the outermost covering portion 132d is set in a range not overlapping the positive electrode active material layer 114 and the negative electrode active material layer 124 in one direction. In the present embodiment, the terminal end 132e of the outermost covering portion 132d is provided below each of the electrodes 110 and 120.

As shown in FIGS. 3 and 4, the upper folded portions 132b, the lower folded portions 132c, and the outermost covering portions 132d are provided with discharge holes H for discharging the gas generated in the electrode assembly 100. As shown in FIG. 3, the discharge hole H provided in the outermost covering portion 132d overlaps the discharge hole H provided in the upper folded portion 132b and the discharge hole H provided in the lower folded portion 132c in the top-bottom direction. Each discharge hole H is formed by laser irradiation or the like.

As shown in FIG. 4, the plurality of discharge holes H arranged along the width direction (the left-right direction in FIG. 4) are preferably provided at equal intervals. It is preferable that a plurality of discharge holes H arranged along the longitudinal direction (top-bottom direction in FIG. 4) of the separator 130 before the separator 130 is formed in a fanfold shape are provided at equal intervals. The dimension W between the pair of discharge holes H adjacent to each other in the width direction is preferably set equal to the dimension L between the pair of discharge holes H adjacent to each other in the longitudinal direction of the separator 130. For example, the diameter of each discharge hole H is set to 100 μm, and the dimension W and the dimension L are set to 500 μm.

The cell case 200 contains the electrode assembly 100. The cell case 200 contains an electrolyte solution (not shown). The cell case 200 is sealed. The cell case 200 includes a case body 210 and a lid 220.

The case body 210 has an opening that opens upward. The case body 210 is made of metal such as aluminum. As shown in FIG. 2, the case body 210 includes a bottom wall 212 and a peripheral wall 214. The bottom wall 212 is formed in a rectangular and flat plate shape. The peripheral wall 214 rises from the bottom wall 212. The peripheral wall 214 is formed in a quadrangular cylindrical shape. The length of the peripheral wall 214 in the width direction is longer than the length of the peripheral wall 214 in the thickness direction. The length of the peripheral wall 214 in the height direction is longer than the length of the peripheral wall 214 in the thickness direction.

The lid 220 closes the opening of the case body 210. The lid 220 is connected to the opening by welding or the like. The lid 220 is formed in a flat plate shape. The lid 220 is made of metal such as aluminum. The lid 220 includes a pressure release valve 222 and a sealing member 224.

The pressure release valve 222 is formed at the center of the lid 220. The pressure release valve 222 is formed so as to break when the internal pressure of the cell case 200 becomes equal to or higher than a predetermined pressure. When the pressure release valve 222 breaks, the gas in the cell case 200 is released to the outside of the cell case 200 through the pressure release valve 222, so that the internal pressure of the cell case 200 decreases.

The sealing member 224 seals the liquid injection port h formed in the lid 220. The liquid injection port h is a through hole for injecting the electrolyte solution into the cell case 200 in the manufacturing process of the power storage cell 1. After the electrolyte solution is injected into the case body 210 through the liquid injection port h, the liquid injection port h is sealed by the sealing member 224.

The pair of external terminals 300 is fixed on the cell case 200. One of the pair of external terminals 300 is a positive electrode external terminal and the other is a negative electrode external terminal. Each external terminal 300 is fixed to the upper surface of the lid 220 via an upper insulating portion 510 described later. Each external terminal 300 is made of a metal such as aluminum. Each external terminal 300 is formed, for example, in a rectangular parallelepiped shape. A bus bar (not shown) is connected to each external terminal 300 by welding or the like.

The pair of connecting members 400 connects the plurality of electrode tabs 112p and 122n to the external terminal 300. One of the connecting members 400 connects the plurality of positive electrode tabs 112p and the positive electrode external terminal 300, and the other connecting member 400 connects the plurality of negative electrode tabs 122n and the negative electrode external terminal 300. Since each of the pair of connecting members 400 has substantially the same structure, one of the connecting members 400 will be described below.

The connecting member 400 includes a current collector tab 410, a sub-tab 420, and a connecting pin 430.

The current collector tab 410 has a lateral portion 412 and an upper portion 414. The lateral portion 412 is positioned on the lateral side of the electrode assembly 100 in the width direction. The upper portion 414 is positioned above the electrode assembly 100. The upper portion 414 extends inward in the width direction from the upper end of the lateral portion 412.

The sub-tab 420 connects the plurality of positive electrode tabs 112p to the current collector tab 410. One end 422 of the sub-tab 420 is connected to the plurality of positive electrode tabs 112p by welding or the like, and the other end 424 of the sub-tab 420 is connected to the lateral portion 412 of the current collector tab 410 by welding or the like.

The connecting pin 430 connects the current collector tab 410 and the external terminal 300. The connecting pin 430 connects the upper portion 414 and the external terminal 300. Specifically, the lower end of the connecting pin 430 is connected to the upper portion 414 by welding or the like in a state of being inserted into a through hole provided in the upper portion 414, and the upper end of the connecting pin 430 is connected to the external terminal 300 by welding, caulking or the like in a state of being inserted into a through hole provided in the external terminal 300.

The insulating member 500 insulates the cell case 200 from the connecting member 400. The insulating member 500 includes an upper insulating portion 510, a lower insulating portion 520, an insulator 530, and an insulating plate 540.

The upper insulating portion 510 is fixed to the upper surface of the lid 220. The upper insulating portion 510 is disposed between the lid 220 and the external terminal 300. The upper insulating portion 510 is provided with an insertion hole through which the connecting pin 430 is inserted.

The lower insulating portion 520 is fixed to the lower surface of the lid 220. The lower insulating portion 520 is disposed between the lid 220 and the lower portion of the upper portion 414 and the connecting pin 430. The lower insulating portion 520 is provided with an insertion hole through which the connecting pin 430 is inserted.

The insulator 530 is disposed between the connecting pin 430 and the lid 220. The insulator 530 is formed in a cylindrical shape and surrounds the connecting pin 430.

The insulating plate 540 is fixed to the lower surface of the upper portion 414. The insulating plate 540 is disposed above the electrode assembly 100. A through hole is formed in a portion of the insulating plate 540 located below the pressure release valve 222 and a portion of the insulating plate 540 located below the liquid injection port h.

Next, a manufacturing process of the power storage cell 1 will be described with reference to FIG. 5 and the like.

First, while the separator 130 is formed in a fanfold shape a roller (not shown), the electrodes 110 and 120 are alternately disposed between the pair of intervening portions 132a. The roller is formed in a crown shape. That is, the roller is formed in a shape such that its diameter increases from the end portion toward the center portion in the rotational axis direction of the roller. This suppresses the formation of wrinkles in the central portion of the separator 130 in the width direction (direction parallel to the rotation axis of the roller) when the separator 130 is folded.

After winding the outermost covering portion 132d of the separator 130, the terminal end 132e is connected to the outermost covering portion 132d by appropriate means. In FIG. 5, illustration of the discharge hole H is omitted.

Next, as shown in FIG. 5, one end 422 of the sub-tab 420 is connected to the plurality of electrode tabs 112p and 122n by welding or the like. Then, the one end 422 and the plurality of electrode tabs 112p and 122n are bent such that the one end 422 of the sub-tab 420 comes into contact with the lateral portion 412 of the current collector tab 410.

Subsequently, the peripheral surfaces and bottom surfaces of the plurality of electrodes 110 and 120 and the separator 130 are collectively covered with an insulating film (not shown), and then the electrode assembly 100 is inserted into the case body 210. Then, the peripheral edge of the lid 220 is connected to the opening of the case body 210 by welding or the like.

Thereafter, the electrolyte solution is supplied into the cell case 200 through the liquid injection port h, and the liquid injection port h is sealed with the sealing member 224.

As described above, in the power storage cell 1 of the present embodiment, since the discharge holes H are provided in the upper folded portion 132b and the lower folded portion 132c of the separator 130, the gas generated in the electrode assembly 100 is effectively discharged to the outside of the electrode assembly 100 through the discharge holes H. Therefore, the retention of the gas in the electrode assembly 100 is suppressed.

Although the discharge holes H are provided in the upper folded portion 132b and the lower folded portion 132c in the above embodiment, the discharge holes H may be provided in either one of the upper folded portion 132b and the lower folded portion 132c. The discharge hole H provided in the outermost covering portion 132d may be omitted.

The electrode assembly 100 is a member different from the separator 130, and may further include a liquid holding member (not shown) capable of holding an electrolyte solution. The liquid holding member is made of, for example, a porous material. The liquid holding member is provided at an end portion (below the electrode tabs 112p and 122n) of the plurality of electrodes 110 and 120 and the separator 130 in the width direction.

It will be appreciated by those skilled in the art that the exemplary embodiments described above are specific examples of the following aspects.

### [Aspect 1]

A power storage cell comprising:
an electrode assembly; and
a cell case containing the electrode assembly, wherein
the electrode assembly includes:
   a plurality of electrodes arranged in one direction; and
   a separator formed in a fanfold shape and electrically insulating the plurality of electrodes from each other,
the separator includes:
   a plurality of intervening portions each intervening between a pair of electrodes adjacent to each other in the one direction;
   an upper folded portion connecting an upper end of one intervening portion of the plurality of intervening portions, and an upper end of an intervening portion of the plurality of intervening portions that is located on one side in the one direction and adjacent to the one intervening portion; and
   a lower folded portion connecting a lower end of the one intervening portion of the plurality of intervening portions, and a lower end of an intervening portion of the plurality of intervening portions that is located on the other side in the one direction and adjacent to the one intervening portion, and
at least one of the upper folded portion and the lower folded portion is provided with a discharge hole for discharging gas.

In this power storage cell, since the discharge hole is provided in at least one of the upper folded portion and the lower folded portion of the separator, gas generated in the electrode assembly is effectively discharged to the outside of the electrode assembly through the discharge hole. Therefore, gas is prevented from staying in the electrode assembly.

### [Aspect 2]

The power storage cell according to Aspect 1, wherein
the separator further includes an outermost covering portion covering the upper folded portion and the lower folded portion collectively, and
the outermost covering portion is provided with the discharge hole.

### [Aspect 3]

The power storage cell according to Aspect 2, wherein the discharge hole provided in the outermost covering portion overlaps, in a top-bottom direction, with the discharge hole provided in at least one of the upper folded portion and the lower folded portion.

According to this aspect, gas is discharged more smoothly through the discharge hole formed in at least one of the upper folded portion and the lower folded portion and the discharge hole formed in the outermost covering portion.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage cell comprising:
an electrode assembly; and
a cell case containing the electrode assembly, wherein
the electrode assembly includes:
a plurality of electrodes arranged in one direction; and
a separator formed in a fanfold shape and electrically insulating the plurality of electrodes from each other,
the separator includes:
a plurality of intervening portions each intervening between a pair of electrodes adjacent to each other in the one direction;
an upper folded portion connecting an upper end of one intervening portion of the plurality of intervening portions, and an upper end of an intervening portion of the plurality of intervening portions that is located on one side in the one direction and adjacent to the one intervening portion; and
a lower folded portion connecting a lower end of the one intervening portion of the plurality of intervening portions, and a lower end of an intervening portion of the plurality of intervening portions that is located on the other side in the one direction and adjacent to the one intervening portion, and
at least one of the upper folded portion and the lower folded portion is provided with a discharge hole for discharging gas.

2. The power storage cell according to claim 1, wherein
the separator further includes an outermost covering portion covering the upper folded portion and the lower folded portion collectively, and
the outermost covering portion is provided with the discharge hole.

3. The power storage cell according to claim 2, wherein the discharge hole provided in the outermost covering portion overlaps, in a top-bottom direction, with the discharge hole provided in at least one of the upper folded portion and the lower folded portion.
